(19) United States
(12) Patent Application Publication
(10) Pub. No.: US 2007/0277584 A1
(43) Pub. Date: Dec. 6, 2007

(54) System for Testing the Functionality of a Sensor Device

(75) Inventors: Thomas Fischer, Beratzhausen (DE); Helmuth Orlogi, Regensburg (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/663,256

(22) PCT Filed: Feb. 10, 2006
(86) PCT No.: PCT/EP06/50836

§ 371 Date: Mar. 19, 2007

(30) Foreign Application Priority Data
Feb. 28, 2005 (DE) 10 2005 009 102.4

(51) Int. Cl. B60R 21/34

(52) U.S. Cl. 73/1.01

(57) ABSTRACT

A system tests the functionality of a sensor device which is formed by way of at least one sensor element and is connected to a first evaluation unit in order to generate a signal indicating an impact. A second evaluation unit that is connected to the sensor device is provided for testing the functionality of the sensor device. The evaluation units are connected to a central control unit so as to trigger a pedestrian protecting device while being synchronized in such a way that the evaluation units trigger the sensor device in a time-multiplexing mode of operation.

Within the field of protection systems in motor vehicles, the introduction of a pedestrian protection system in addition to occupant protection has been the focus of discussion for quite some time. The intention of such a system is to detect whether the motor vehicle impacts with a pedestrian and to activate suitable protection mechanisms if necessary. Such protection mechanisms can comprise airbags on the hood for instance or on the A-pillars of the motor vehicle or raising the hood by a few centimeters in order to soften the impact of the pedestrian's head on the hood.

To detect a pedestrian impact, DE 100 30 465 A1 proposes to provide sensors on the bumper and on the hood of the motor vehicle, which can detect the chronological sequence of a typical pedestrian impact. Resistance strain gauges or piezoresistive films and also optical sensors are proposed there as sensors, said optical sensors having a light permeability which is dependent on pressure. To increase the reliability of this system, a further decision criterion is formed in addition to the impact detection, by determining the speed and/or acceleration changes of the motor vehicle caused by an impact and then comparing these speed and/or acceleration changes with reference parameters which are typical for pedestrian impact. The sensors of this pedestrian impact device, and in fact both the optical sensors as well as the acceleration sensors, are directly connected to the central control unit by way of their data lines, so that a higher cabling outlay is required, which is actually even greater by virtue of the requirements of the supply voltage lines for the individual sensors. Furthermore, the use of two sensors for increasing reliability is complex and thus expensive.

The object underlying the invention is thus to specify a system with a sensor device which is formed by means of at least one sensor element, said sensor device being connected to an evaluation unit in order to generate a signal indicating an impact, said system being able to test the functionality of the sensor device in a simple manner.

The object is achieved by means of a system according to claim 1. Advantageous developments are specified in the subclaims.

Consequently a second evaluation unit synchronized with the first evaluation unit is provided such that the sensor device can be controlled by both of the evaluation units in time division multiplex mode. In this way, the functionality of the sensor device can be tested in a simple manner and, in an advantageous development of the invention, a fault signal can be transmitted to a central control device connected to the evaluation units if the sensor device is not functioning correctly, said fault signal disabling the triggering of a pedestrian protection means.

If the sensor device is formed by a number of sensor elements, each sensor element can be tested separately in an advantageous development of the invention. In cases in which a sensor element is faulty, the system with the remaining functional sensor elements can be continue to be operated in emergency mode, with each non-functional sensor element being individually deactivated in a development of the invention.

In a particularly advantageous development of the inventive system, there is provision for enabling the fault signal to be transmitted by modulating the current on a supply voltage line between the evaluation units and the central control unit. This dispenses with the need for a data transmission line.

To ensure particularly high security in respect of the functionality of the sensor device, provision can be made to test the sensor device periodically, with the individual sensor elements able to be queried one after the other in an advantageous configuration. This allows individual faulty sensor elements to be identified and thus individually deactivated.

The invention is described in more detail below with reference to an exemplary embodiment with the aid of figures, in which;

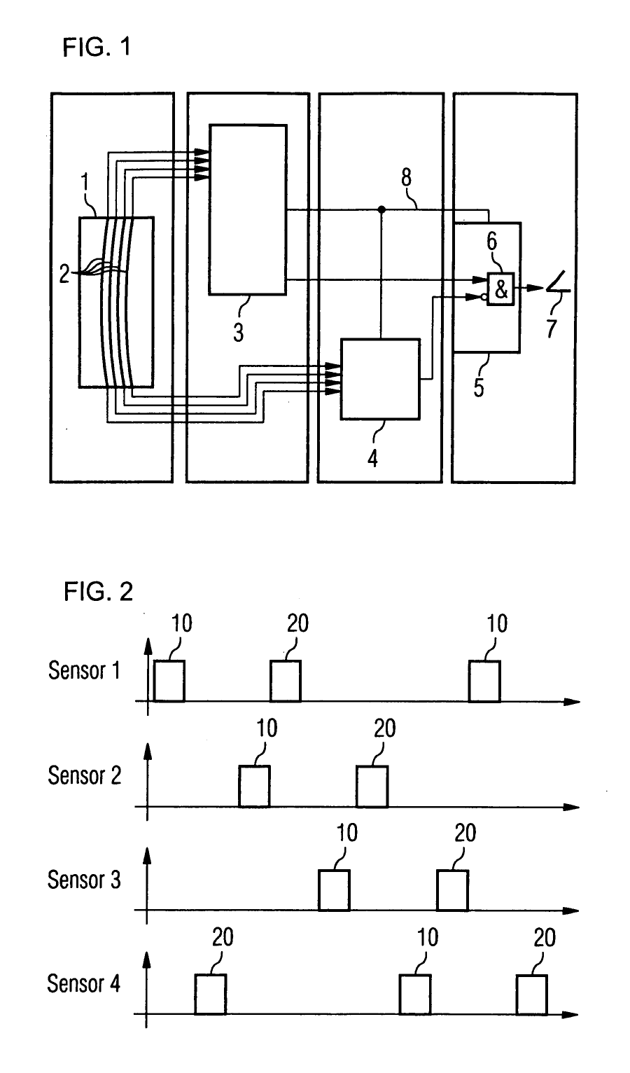

FIG. 1 shows a schematic representation of a system according to the invention and

FIG. 2 shows a schematic diagram of the chronological sequence of sensor device queries.

FIG. 1 shows a sensor device 1, which is formed by four sensor elements 2 in the example displayed. The sensor device is connected on the one hand to a first evaluation unit 3 by means of four lines and on the other hand to a second evaluation unit 4, likewise by means of four lines. It is connected to the first and also to the second evaluation unit 3, 4 in a similar manner to each sensor element 2 with its own line.

The first evaluation unit 3 can test the functionality of the sensor elements 2 of the sensor device 1 on the one hand but, by evaluating the signals of the sensor elements 2, can also detect on the other hand whether a force has occurred as a result of the impact on the bumper of a motor vehicle for instance, in which the sensor device 1 is arranged. The sensor elements 2 of the sensor device 1 can be formed here with any type of pressure-sensitive sensors, with a fiberoptic sensor being used in a particularly advantageous manner, the light conductivity of which changes as a result of the effect of a force, so that by measuring the light intensity in the first evaluation unit 3 it is possible to determine whether the optical fiber has been deformed. The first evaluation unit 3 can be formed here in an advantageous manner with a microprocessor.

The second evaluation unit 4 is only intended to test the functionality of the sensor elements 2 of the sensor device 1 and can thus be designed in a simpler fashion. It is however likewise possible to use a microprocessor for this purpose. The functionality of the sensor elements 3 of the sensor device 1 can be tested for instance such that in cases where optical fibers are used as sensor elements 2, a test is carried out to determine whether the received light intensity corresponds to an expected light intensity.

In accordance with the evaluation of the signals of sensor device 1 carried out by the first evaluation unit 3 and the second evaluation unit 4, said evaluation units 3, 4 supply the output signals to a central control unit. This is linked to the two evaluation units 3, 4 by way of a supply voltage line 8, whereby these are supplied with a supply voltage. In the central control unit 5, which is advantageously formed by a microprocessor, the output signals of the two evaluation unit 3 and 4 are coupled to one another, this being indicated by means of a logical gate 6, whereby the triggering of a pedestrian protection means 7 which is shown in the illustrated exemplary embodiment as a hinged hood, can be disabled if the sensor device 1 does not have the required functionality.

In an advantageous embodiment of the system according to the invention, the functionality of each individual sensor element 2 can be determined and, if only a few sensor elements 2 are detected as faulty, an emergency mode can be maintained using the remaining sensor elements. Accordingly, the processing of the signals of the first evaluation device 3 can be suppressed in the central control unit 5 because of the faulty sensor elements 2.

Instead of transferring the output signal from the second evaluation unit 4 on a separate line, as shown in the exemplary embodiment in FIG. 1, the signal of the second evaluation unit 4 can alternatively be carried by modulating the current on the supply line 8. This advantageously saves one line. The modulation can be carried out in the second evaluation unit 4 by interconnecting the supply voltage line 8 with a variable resistor, the load path of a transistor for instance. This current modulation can be detected in the central control unit 5 by measuring the voltage drop on a longitudinal resistor in the supply voltage line 8.

As both evaluation units 3, 4 are connected to the sensor elements 2 of the sensor device 1, the sensor elements 2 are inventively queried in time division multiplex mode, this being shown schematically in FIG. 2. A sensor value from the first evaluation unit 3 is first measured during a period 10. During a period 20 the sensor is then tested for a correct function by means of the second evaluation unit 4. This process can be repeated at intervals in an advantageous manner. All the sensor elements 2 can in principal be queried simultaneously or, as in the example in FIG. 2, can be queried in successive time slots.

The system according to the invention enables a signal from the sensor unit 1 determined by the first evaluation unit 3, said sensor unit indicating an impact, to only then result in the pedestrian protection means 7 being triggered if the second evaluation unit 4 has established that the sensor elements 2 of the sensor device 1 are functioning correctly.

1-8. (canceled)

9. A system for testing a functionality of a sensor device formed with at least one sensor element, the system comprising:
a first evaluation unit connected to the sensor device for generating a signal indicating an impact;
a second evaluation unit connected to the sensor device for testing the functionality of the sensor device;
said first evaluation unit and said second evaluation unit being synchronized to control the sensor device in time division multiplex mode; and
a central control unit connected to said first evaluation unit and said second evaluation unit for triggering a pedestrian protection function.

10. The system according to claim 9, wherein said second evaluation unit is configured to transmit a fault signal to said central control unit in the absence of functionality of the sensor device, said fault signal disabling the triggering of the pedestrian protection function.

11. The system according to claim 9, wherein the at least one sensor element is one of a plurality of sensor elements, and each sensor element is connected to be tested separately.

12. The system according to claim 9, wherein the at least one sensor element is one of a plurality of sensor elements, and each sensor element is connected to be individually deactivated.

13. The system according to claim 10, which comprises a supply voltage line connected between said evaluation units and said central control unit, wherein the fault signal is transmitted by modulating a current on said supply voltage line.

14. The system according to claim 9, wherein said first and second evaluation units are configured to periodically query the sensor device in time division multiplex mode.

15. The system according to claim 14, wherein the at least one sensor element is one of a plurality of sensor elements, and the sensor elements are queried one after another.

16. The system according to claim 14, wherein the at least one sensor element is one of a plurality of sensor elements, and the sensor elements are queried simultaneously.
